(19) United States
(12) Patent Application Publication
(10) Pub. No.: US 2024/0264801 A1
(43) Pub. Date: Aug. 8, 2024

(54) 1-HOT PATH SIGNATURE ACCELERATOR

(71) Applicant: Arm Limited, Cambridge (GB)

(72) Inventors: Brendan James MORAN, Coton (GB); Michael BARTLING, Austin, TX (US); Andreas Lars SANDBERG, Cambridge (GB)

(21) Appl. No.: 18/106,274

(22) Filed: Feb. 6, 2023

(51) Int. Cl. G06F 7/501; G06F 5/01

(52) U.S. Cl. CPC G06F 7/501; G06F 5/01

(57) ABSTRACT

A 1-hot path signature accelerator includes a register, first and second accumulator, and an outer product circuit. The register stores an input frame, where the input frame has, at most, one bit of each element set. The first accumulator calculates a present summation by adding the input frame to a previous sum of previous input frames inputted to the 1-hot path signature accelerator within a timeframe. The outer product circuit receives each element of the present summation from the first accumulator and each element of the input frame stored in the register to output a present outer product. Since the input frame has at most one bit of each element set, the outer product circuit is reduced to a logical operation. The second accumulator outputs a present second-layer summation by adding the present outer product to a previous second-layer sum of outputs from the outer product circuit within the timeframe.

### BACKGROUND

A hardware accelerator is a specialized circuit designed to perform a particular function more efficiently than a more generalized circuit, such as a processor, executing code to perform the particular function. By designing the circuit specifically to perform a particular function (e.g., a particular type of calculation), efficiency of the function can be improved. For example, a hardware accelerator can streamline calculations by using simplified circuit architectures or pipeline phases of a calculation to perform different subcalculations simultaneously.

### BRIEF SUMMARY

A 1-hot path signature accelerator is provided. As path signature calculations can be intensive, performing such calculations on live data in real time can be costly in terms of processing requirements. A 1-hot path signature accelerator such as described herein can support more efficient computation to construct a path signature from an input stream of data in real time.

A 1-hot path signature accelerator uses an outer product circuit to accelerate computations. An outer product circuit takes two vectors A and B, with m and n elements, respectively, and multiplies each A[i] with B[j] to create a result vector C with m x n elements. Advantageously, when the input to the outer product circuit is constrained to having, at most, one bit of each element set, the outer product circuit reduces to a logical operation.

Such a 1-hot path signature accelerator includes a register for storing an input frame where the input frame has at most one bit of each element set; a first accumulator for calculating a present summation by adding the input frame to a previous sum, wherein the previous sum is the sum of all previous input frames inputted to the 1-hot path signature accelerator within a timeframe; an outer product circuit that receives each element of the present summation from the first accumulator and each element of the input from stored in the register to output a present outer product, wherein the outer product circuit is reduced to a logical operation by the input frame having at most one bit of each element set; and a second accumulator that outputs a present second-layer summation by adding the present outer product to a previous second-layer sum of outputs from the outer product circuit within the timeframe. The above-described circuitry of the register, outer product circuit, and second accumulator can be considered parts of a 1-hot path signature accelerator component and provided in plurality in a 1-hot path signature accelerator system to achieve the appropriate depth signature.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a simple implementation of a 1-hot path signature accelerator.

FIG. 2 illustrates an example 1-hot path signature accelerator system.

FIGS. 3A-3D illustrate example outer product circuits for a 1-hot path signature accelerator.

FIGS. 4A and 4B illustrate example latched bit circuits for a 1-hot path signature accelerator.

FIGS. 5A and 5B illustrate circuits for temporal preservation of inputs for use in a 1-hot path signature accelerator.

FIGS. 6A-6C illustrate various example N-hot path signature accelerators.

FIG. 7 illustrates an embodiment of a logarithmic-based 1-hot path signature accelerator.

### DETAILED DESCRIPTION

A 1-hot path signature accelerator is provided. As path signature calculations can be intensive, performing such calculations on live data in real time can be costly in terms of processing requirements. A 1-hot path signature accelerator such as described herein can support more efficient computation to construct a path signature from an input stream of data in real time.

A path signature is a representation of the path that a signal takes from a start time to an end time. The path signature can be the path of code that may have various branching options or the path of a stylus during an inking function of an inking program as some examples. The path signature can be in the form of time series data.

Unfortunately, a path signature can be expensive to construct. The size of a path signature grows exponentially with depth (e.g., how much detail a particular path signature captures) and dimension (e.g., “length” of how many samples are in the signature or how large the data in the time series is). Typically, the signature is computed using Kronecker products and summations, meaning typically one Multiply-and-Accumulate is performed for each element of the signature for every record, which can quickly get computationally expensive.

A 1-hot path signature accelerator as described herein takes in an input stream of data from a data source and produces a path signature of at least two layers.

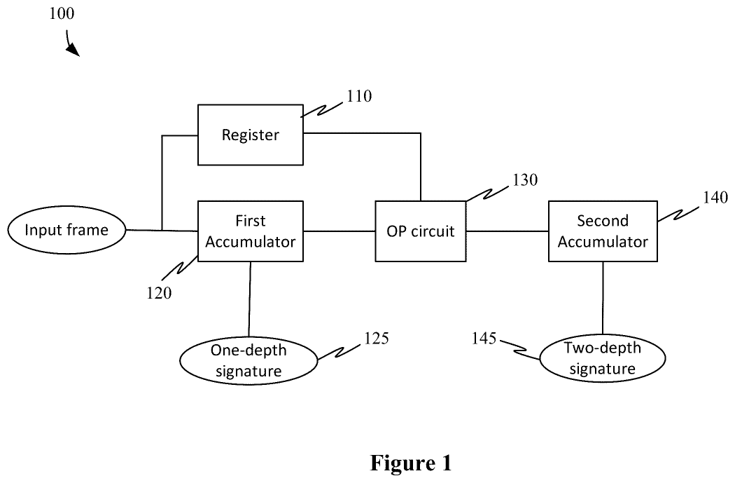

FIG. 1 illustrates a simple implementation of a 1-hot path signature accelerator. Referring to FIG. 1, a 1-hot path signature accelerator 100 includes a register 110, a first accumulator 120, an outer product circuit 130, and a second accumulator 140. The 1-hot path signature accelerator 100 uses the outer product circuit 130 to accelerate computations. An outer product circuit takes two vectors A and B, with m and n elements, respectively, and multiplies each A[i] with B[j] to create a result vector C with m x n elements. Advantageously, when the input to the outer product circuit is constrained to having, at most, one bit of each element set, the outer product circuit reduces to a logical operation.

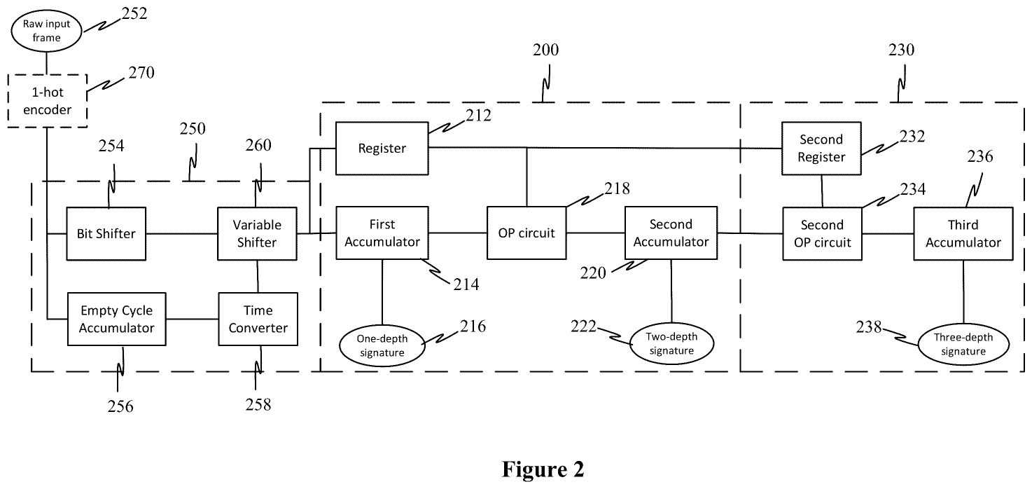

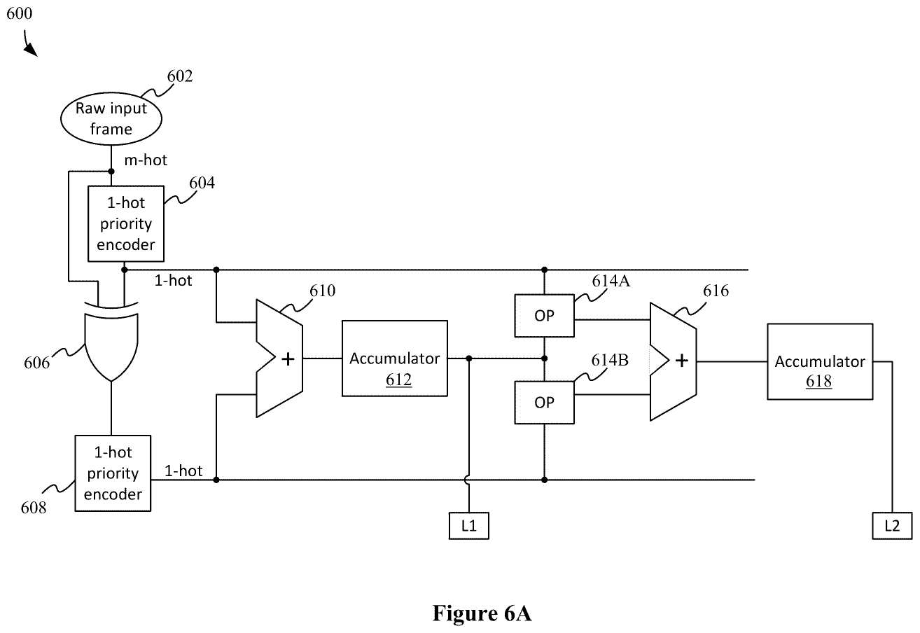

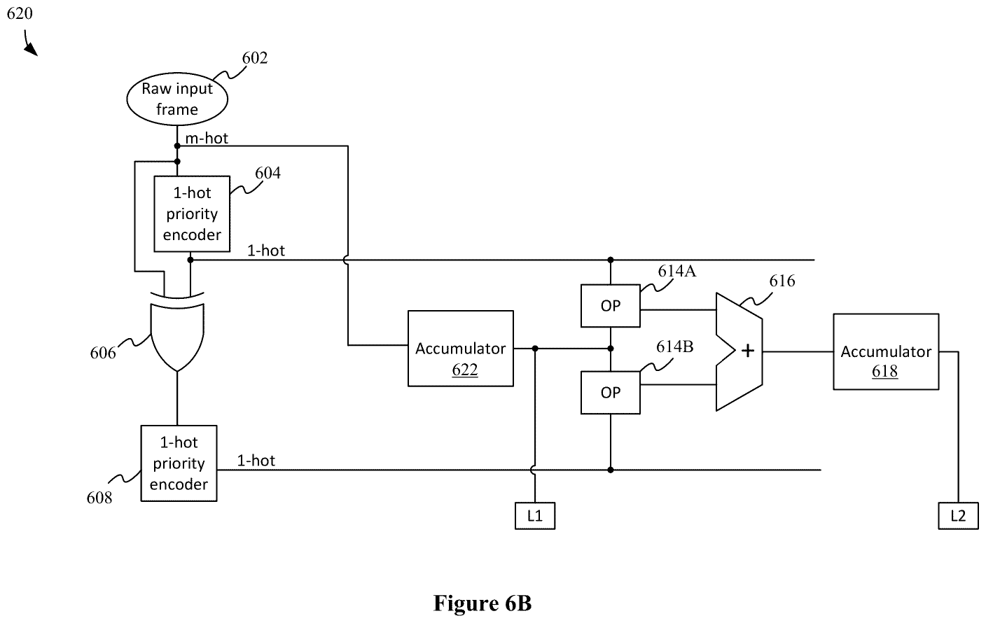

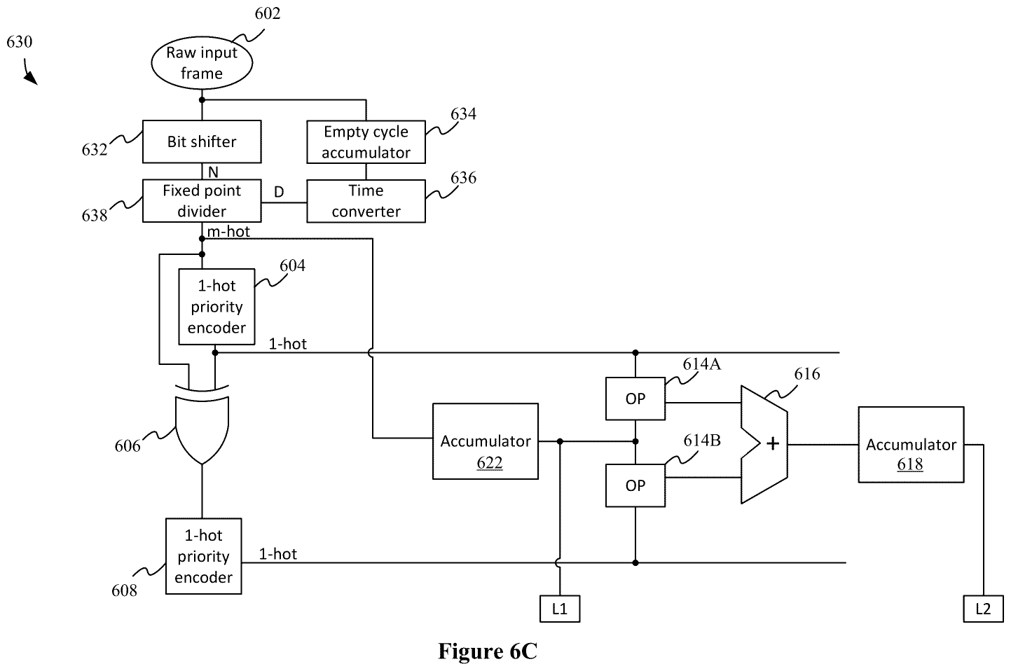

The register 110 (or other storage resource) and first accumulator 120 both receive an input frame. In particular, the register stores a 1-hot signal, where the 1-hot signal has, at most, one bit of each element set of the input frame. In some cases, such as shown in FIGS. 6A-6C where there are multiple 1-hot busses, the register 110 (or other storage resource) can be considered to receive a portion of the input frame. The input frame can be an event frame from an event trace window. An event trace is a time series of individual events occurring at a source (e.g., a processing unit or other component being monitored). In some cases, the event frame is received directly from a performance monitoring unit (PMU) or other event source. The input frame can undergo pre-processing via a pre-circuit that receives and formats the input frame for easier processing by the 1-hot path signature accelerator 100. An example pre-circuit is shown in FIG. 2.

Once the input frame is received, the register 110 stores the frame for later use. The first accumulator 120 calculates a present summation by adding the input frame to a previous sum. The previous sum can be all previous input frames inputted to the 1-hot path signature accelerator within a timeframe. The timeframe can either be static (e.g., every 256 cycles, a new timeframe begins and the previous sum is cleared) or rolling (e.g., the accumulator only considers the previous 256 cycles, shifting by a portion such as one half (e.g., 128 cycles),—or some other number—at a time). The present summation can be saved and considered a one-depth signature 125. In some cases, the one-depth signature 125 is output from the 1-hot path signature accelerator 100 to another system directly. In other cases, the one-depth signature 125 is saved in a storage resource in the 1-hot path signature accelerator 100.

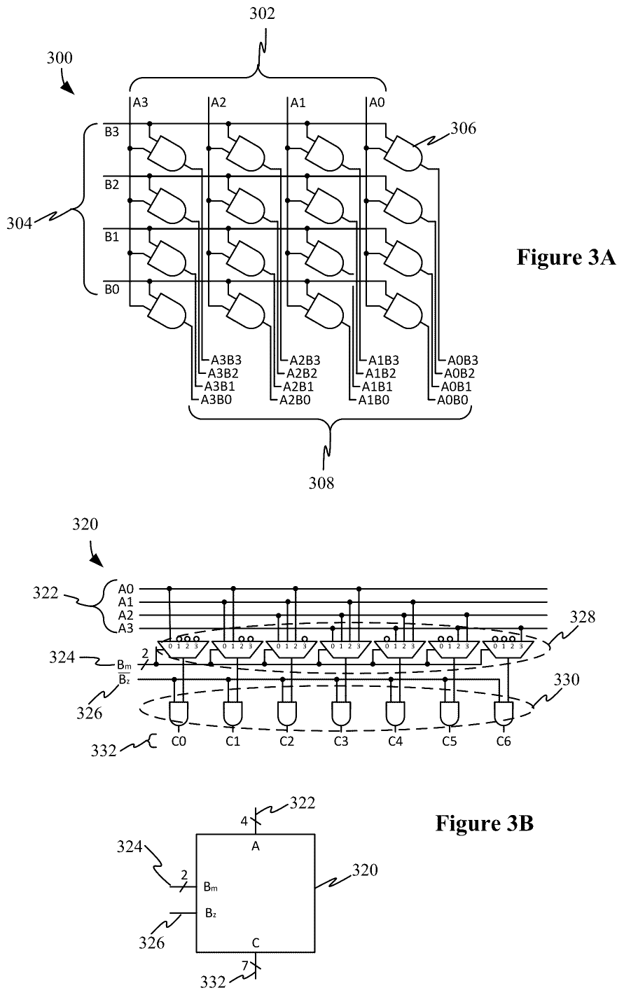

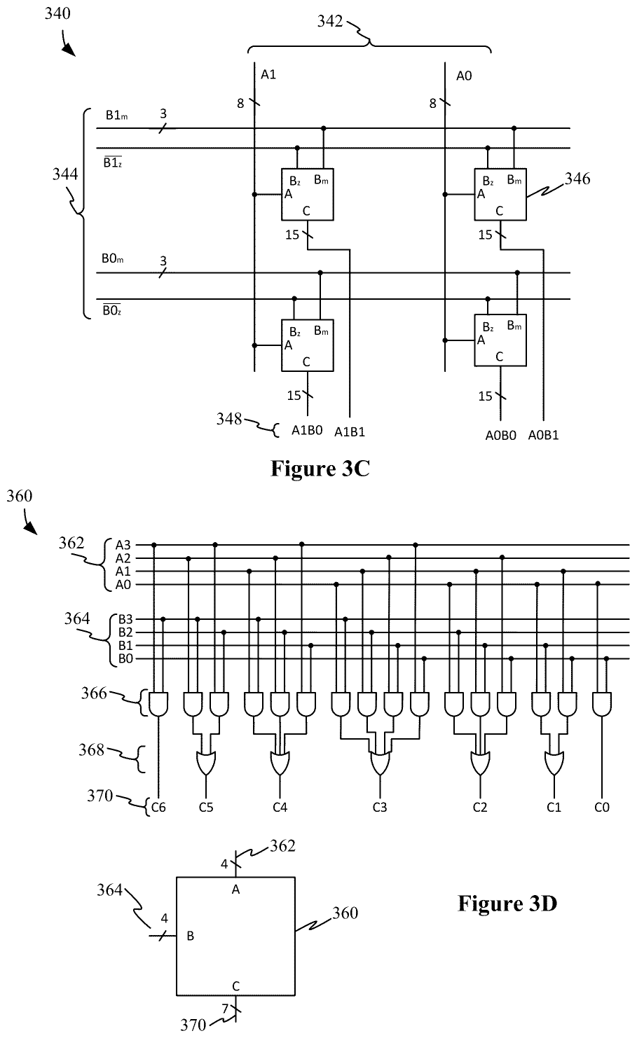

The present summation is output from the first accumulator 120 to the outer product circuit 130. The outer product circuit 130 is also coupled to the register 110 to receive the input frame. The outer product circuit 130 receives each element of the present summation from the first accumulator 120 and each element of the input frame stored in the register 110 to output a present outer product. Since the input frame has at most one bit of each element set, the outer product circuit 130 is reduced to a logical operation. Some example embodiments of the outer product circuit 130 are shown in FIGS. 3A-3D.

A second accumulator 140 is coupled to receive the present outer product from the outer product circuit 130. The second accumulator 140 can calculate a present second-layer summation by adding the present outer product to a previous second-layer sum of outputs from the outer product circuit 130 within the timeframe. The present second-layer summation can be saved as a two-depth signature 145. In some cases, the two-depth signature 145 is output from the 1-hot path signature accelerator 100 to another system directly. In other cases, the two-depth signature 145 is saved in a storage resource in the 1-hot path signature accelerator 100. If saved in a storage resource, in some cases the two-depth signature 145 is saved in the same storage and associated with the one-depth signature 125.

FIG. 2 illustrates an example 1-hot path signature accelerator system. The expanded system shown in FIG. 2 can broadly be considered to include three subsystems: a base path signature accelerator 200, a higher-layer calculation circuit 230, and a pre-circuit 250. In some cases, the different subsystems can share components (e.g., a register used in the base path signature accelerator 200 can also be coupled to components in the higher-layer calculation circuit 230 and so considered shared between the two).

The base path signature accelerator 200 includes the components of the 1-hot path signature accelerator as described in FIG. 1. In particular, the base path signature accelerator 200 includes a register 212, a first accumulator 214, an outer product circuit 218, and a second accumulator 220. In some cases, an extended implementation to an N-hot path signature accelerator such as described with respect to FIGS. 6A-6C may be used. The register 212 and first accumulator 214 can be coupled to receive an input frame (in this case, from the pre-circuit 250). The first accumulator 214 calculates a present summation (also referred to as a one-depth signature 216) by adding the input frame to a previous sum and outputs the present summation to the outer product circuit 218.

The outer product circuit 218 receives the present summation from the first accumulator 214 and is also coupled to the register 212 to receive the input frame. The outer product circuit 218 calculates a present outer product of the input frame and the present summation. A second accumulator 220 is coupled to the outer product circuit 218 to receive the present outer product. The second accumulator 220 can calculate a present second-layer summation by adding the present outer product to a previous second-layer sum of outputs from the outer product circuit 218 within the timeframe. The second accumulator 220 can output or store the present second-layer summation as a two-depth signature 222, which can be independent of or associated with the one-depth signature 216.

The higher-layer calculation circuit 230 can calculate a higher-depth signature. As shown, the higher-layer calculation circuit 230 includes a second register 232 coupled to the register 212 from the base path signature accelerator 200 to receive and store the input frame. In some cases, the register 212 from the base path signature accelerator 200 and the second register 232 from the higher-layer calculation circuit 230 are configured to both receive the input frame directly. In some cases, the input frame timing to the register 212 and the second register 232 is such that the base path signature accelerator 200 is able to calculate the next input frame simultaneous to the higher-layer calculation circuit 230 calculating the present input frame. In some cases, the second register 232 is omitted and the second outer product circuit 234 of the higher-layer calculation circuit 230 is coupled to the register 212 from the base path signature accelerator 200 to receive the input frame.

The higher-layer calculation circuit 230 includes a second outer product circuit 234 coupled to the second register 232 and the second accumulator 220 to receive the input frame and the present second-layer summation, respectively. The second outer product circuit 234 can include a series of logic gates that perform a logical operation between each bit of a present summation output from the immediately previous accumulator (in this case, the second accumulator 220) and each bit of the input stored in the second register 232 to calculate a present higher-level outer product.

The higher-layer calculation circuit 230 includes a third accumulator 236. The third accumulator 236 receives the present higher-level outer product from the second outer product circuit 234 and calculates a present higher-layer summation by adding the present higher-level outer product from the second outer product circuit 234 to a previous higher-layer sum of outputs from the second outer product circuit 234 within the timeframe. The present higher-layer summation can be output directly or stored as a three-depth signature 238, which can be independent of or associated with the one-depth signature 216 and the two-depth signature 222.

Although only one higher-layer calculation circuit 230 is depicted here, further higher-layer calculation circuits can be included, each at least with an outer product circuit and an accumulator. For example, a second higher-layer calculation circuit can be included coupled to the third accumulator 236 in the higher-layer calculation circuit 230 and include a third register or be coupled to receive the input frame from the register 212 or the second register 232 such that an outer product circuit can generate a third outer product which is used by a fourth accumulator to generate a four-depth signature.

The pre-circuit 250 can be used to obtain inputs and format the inputs for easier processing by the base path signature accelerator 200. In the illustrated embodiment, the pre-circuit 250 is a time-weighting circuit and includes a bit shifter 254, an empty cycle accumulator 256, a time converter 258, and a variable shifter 260. Such a circuit allows for time information to be included in the input signal without having to use time as a dimension in the input; thus avoiding computationally intensive processing.

The bit shifter 254 and the empty cycle accumulator 256 are coupled to an input bus to receive a raw input frame 252. The input bus can be, for example, connected to a PMU or some other source of data inputs. In the case of monitoring code functionality, the inputs can represent events of the processor or issues that have arisen during execution of code. There can be, for example, five different types of events predefined by the system—for example, cache miss, branch miss-predict—and an input frame in the form of an event frame can include all events detected in a particular cycle. In some cases, more or fewer types of events could be monitored. Speed of inputs can vary as well. For monitoring code functionality, inputs can be received on the order of GHz. As another example, inputs can include horizontal position, vertical position, and horizontal displacement (for inking). Any sources of inputs can be used where the raw input frame 252 is one-hot—i.e., including no more than one set bit in a given raw input frame 252.

The bit shifter 254 can left-shift the raw input frame 252 a predefined number of times, for example eight times, to produce a shifted input frame. In this example, each bit of the raw input frame 252 is separated and shifted to be an eight-bit signal. As is typical in shifters, bits added during left-shift can be zeroes rather than ones. The left-shift operation provides a fixed-point encoding of the input, which is used in the time-weighting implementation of the pre-circuit 250. Either the accumulator 256 or outer product circuit discards the lower N bits of the result for a MxN fixed point encoding. When the accumulator is used to discard the lower N bits, the accumulator is sized N bits larger than otherwise. When the outer product circuit is used to discard the lower N bits, loss of precision at the start of the input frames can be minimized by preloading all the accumulators with 1<<N at the beginning of a timeframe.

The empty cycle accumulator 256 can be a circuit designed to count the number of empty cycles (i.e., cycles where there are no set bits). The empty cycle accumulator 256 can be, for example triggered on a clock cycle (that can be the same clock cycle associated with the loading of the raw input frame 252 in the input bus) and increment upon receiving a clock signal unless reset. The empty cycle accumulator can also include a reset pin—where the reset pin detects whenever a set bit is in a currently processing raw input frame 252 (e.g., an OR gate that ORs all inputs). In some cases, the empty cycle accumulator 256 can be a circuit designed to only count the number of times a specific event is present. For example, the empty cycle accumulator 256 can be configured to count the “Active Cycles” event, which appears when a CPU is not stalled, which allows for any stalls of the CPU to be ignored when examining CPU behavior (and when such information is the input to the accelerator).

For an input frame consisting of 1-bit elements, the shifters can also be implemented purely as a bank of “AND” gates, where one input is an element of the input frame, and the other input corresponds to one bit of the time converter's 1-hot output. This approach again exploits 1-hot encoding to reduce two shifters and a priority encoder down to a simple bank of AND gates.

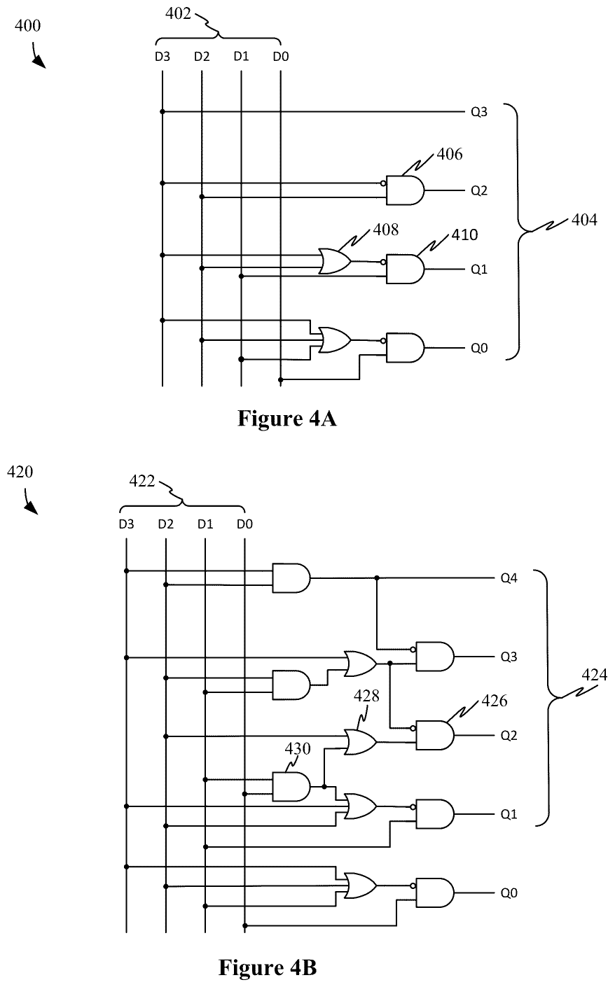

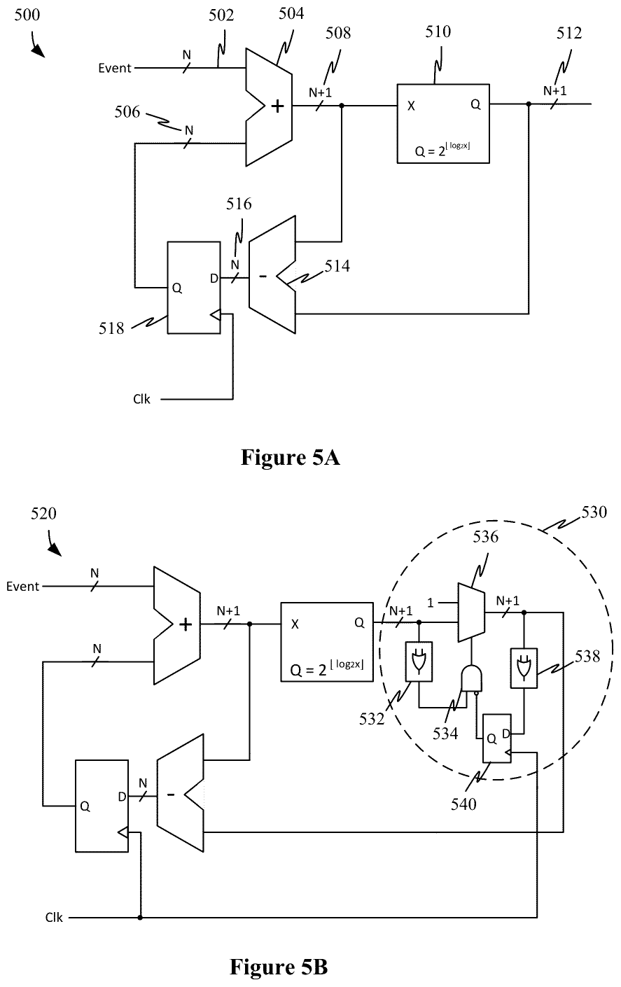

In some cases, a 1-hot encoder 270 can be included to encode a non-1-hot input signal into 1-hot input frames, which simplifies the output of the empty cycle accumulator 256 to a 1-hot signal, for example, when attempting to preserve time information. In some cases, the 1-hot encoder includes a bit latch. Examples of bit latches are shown in FIGS. 4A and 4B. The temporal preservation circuits of FIGS. 5A and 5B may also be used to implement the 1-hot encoder 270.

In some cases, the empty cycle accumulator 256 can include feedback to allow for temporal preservation of inputs. Examples of circuits for temporal preservation of inputs are shown in FIGS. 5A and 5B.

The time converter 258 is coupled to the empty cycle accumulator 256. The present output of the empty cycle accumulator 256 (e.g., the number of cycles that have no set bits) can be received by the time converter 258 when an enable is triggered. The enable can be triggered when the raw input frame 252 includes one or more set bits. The time converter 258 can be implemented using an encoder that triggers when an input is received with set bits. In some cases, the time converter 258 is a priority encoder. Such encoders yield the index of the highest bit. In some cases, the time converter 258 is a modified priority encoder can be used that “rounds up” signals, for example, a 1-hot priority encoder, which yields an output that sets all bits below the highest to 0 (see e.g., the circuit shown in FIG. 4A). In some cases where the time converter 258 is implemented as a 1-hot priority encoder, the time converter 258 can be implemented using bit latches such as shown in FIGS. 4A and 4B to generate a 1-hot encoding of time delay.

The variable shifter 260 can shift the input frame after the input frame is left-shifted by the bit shifter 254. The shifting by the variable shifter 260 can be used to represent time since the last event with a set bit. The variable shifter 260 can be coupled to the time converter 258 to determine the time since the last event with a set bit and also be coupled to the bit shifter 254 to receive the shifted input frame. Based on the value received from the time converter 258, the shifted input frame can be shifted a number of times. The shifted input frame could be shifted left or right depending on how the base path signature accelerator 200 is configured.

The variable shifter 260 can be embodied, for example, as a series of multiplexors where the value from the time converter 258 selects from sequential bits from the output of the bit shifter 254. In some cases, when the variable shifter 260 is implemented as the series of multiplexors, it is possible to omit the bit shifter 254. In some cases that omit the bit shifter 254, the variable shifter 260 can be integrated into a single right-shifter with an offset.

Another implementation of the variable shifter 260 is a demultiplexor, for example a 1-to-8 demultiplexor. If a demultiplexor is used for the variable shifter 260, it is also possible to omit the bit shifter 254 and use a bit from the raw input frame 252 directly. In addition, the value from the time converter 258 can once again be coupled to select pins. In an example implementation, a pre-circuit includes an input bus that receives a raw input frame; an empty cycle accumulator that increments on clock cycles when the raw input frame does not have any set bits and resets when the raw input frame is received with set bits; an encoder (e.g., priority encoder or 1-hot priority encoder) coupled to the empty cycle accumulator that triggers when the raw input frame is received with set bits; and a demultiplexor, wherein input pins of the demultiplexor coupled to the input bus to receive the raw input frame and wherein select lines of the demultiplexor are coupled to the output of the encoder.

In yet another implementation, the variable shifter 260 can be implemented as an outer product circuit such as described with respect to the outer product circuit 218. For example, implemented as illustrated in FIGS. 3B, 3C, and 3D.

In a specific implementation, the pre-circuit 250 includes the empty cycle accumulator 256, where the empty cycle accumulator 256 is an adder, the time converter 258, where the time converter 258 is a bit latch such as shown in FIG. 4A or 4B, and the variable shifter 260, where the variable shifter 260 is an outer product circuit, where the outer product circuit is M×1, where the M inputs are received from a 1-hot encoder 270 or the raw input frame 252 and the x1 input is received from the time converter 258.

FIGS. 3A-3D illustrate example outer product circuits for a 1-hot path signature accelerator. The outer product (also known as the Kronecker product) is an M by N matrix representation of the product of two input vectors of size M and N. In calculating the outer product, each element of a first input vector is multiplied with each element of a second input vector. In the case of 1-hot signature accelerator, at least one of the input vectors is 1-hot (meaning at most only a single bit of each element of the vector is set). The full equation calculated can be expressed as:

$$A ⊗ B = [ \begin{matrix}{A}_{0} {B}_{0} & {A}_{0} {B}_{1} & {A}_{0} {B}_{2} & {A}_{0} {B}_{3} \\ {A}_{1} {B}_{0} & {A}_{1} {B}_{1} & {A}_{1} {B}_{2} & {A}_{1} {B}_{3} \\ {A}_{2} {B}_{0} & {A}_{2} {B}_{1} & {A}_{2} {B}_{2} & {A}_{2} {B}_{3} \\ {A}_{3} {B}_{0} & {A}_{3} {B}_{l} & {A}_{3} {B}_{2} & {A}_{3} {B}_{3}\end{matrix} ] where \\ \begin{matrix}A = [ {A}_{0} {A}_{1} {A}_{2} {A}_{3} ] \\ B = [ {B}_{0} {B}_{1} {B}_{2} {B}_{3} ] \\ {A}_{i} ∈ [ 0 , {2}^{m} - 1 ] ∀ i ∈ [ 0 , 3 ] \\ m is the size of {A}_{i} in bits \\ {B}_{i} ∈ [ 0 , {2}^{j} {\vert}_{j ∈ [ 0 , n ]} ] ∀ i ∈ [ 0 , 3 ] \\ n is the size of {B}_{i} in bits\end{matrix} .$$

In practice, the resultant matrix can be serialized into a {M×N}×1 matrix or a vector where the ordering is not important so long as any re-ordering is consistent (allowing the matrix to be reconstructed later or otherwise knowing which element of the vector corresponds to which calculation).

FIG. 3A illustrates a simplified (e.g., degenerate case) outer product circuit based on two 4-element vectors, with each element having a size of 1 bit. The simplified outer product circuit 300 takes two inputs, in this example a four-element input A 302 and a four-element input B 304. A grid of 4×4 AND gates 306 are coupled each to one bit element of the four-element input A 302 and one bit of the four-digit input B 304. Across the 16 AND gates 306, all combinations of one element of the four-element input A 302 and one element of the four-element input B 304 can be covered and connected exactly once. A 16-element output 308 can be formed by collating the 16 outputs of the 16 AND gates 306. It should be noted that, while both input vectors here have 4 elements, this is not required, and a similar outer product circuit can be constructed for any two input vectors, and the same is true for the designs shown in FIGS. 3A-3D.

FIG. 3B illustrates a shift/AND cell that can calculate one element of an outer product. A shift/AND cell can calculate the outer product with significantly fewer gates than the equivalent multiply operation. Two signals are input to the indexed shift/AND cell 320, a first four-bit signal A 322 and a second signal B. B is broken up into two subsignals before being handled by the multiply cell. The first of the two subsignals BM 324 is the index of the first set bit of B. In this example, B_{M} is log 2B and can be computed by a priority encoder. B_{Z} 326 is a signal that indicates that B is nonzero—the signal can be created for example, by ORing all bits of B. The multiply cell is composed of a series of multiplexors 328 and a series of AND gates 330 that produce a series of outputs 332. In this case, the multiplexors 328 are 4-to-1 multiplexors and use B_{M} 324 as select lines to select between four lines of A 322. The lines of A 322 selected between can be four consecutive lines. For example, for the multiplexor 328 that determines the lowest bit (CO) of the output 332, the 0 input could be the lowest bit of the A 322 and all other lines can be 0. For the multiplexor 328 that determines C3, the 0 input can be A3, the 1 input can be A2, the 2 input can be A1, and the 3 input can be A0. The output pin of a particular multiplexor can be coupled to the input pin of an AND gate 330 along with the B_{Z} 326 signal. The AND gates 330 can each produce an output 332 based on this.

FIG. 3C illustrates how indexed shift/AND cells can be used to construct an outer product. In this example, there are two 16-bit signals to the outer product circuit 340: an input signal A 342 (that is not necessarily 1-hot encoded) and an input signal B 344 (that is 1-hot encoded and which has been reduced to a magnitude and non-zero flag). Input signal A 342 and input signal B (344) are two vectors of 2 elements each. Input signal A 342 can be broken into two orthogonal elements, for example, a designated upper partition and lower partition, while input signal B 344 also has two orthogonal elements, for example, a designated upper partition and lower partition, but both the designated upper partition and the designated lower partition both have been pre-processed in a manner similar to the signal B shown in FIG. 3B and a logarithm has been precalculated (for example, using a priority encoder) and used as an input. In this example, a 2x2 outer product 348 is calculated using four indexed shift/AND cells 346, which can be implemented as described with respect to indexed shift/AND cell 320 of FIG. 3B, to calculate each combination, and calculation of the part of the outer product that each individual cell handles is done as described in FIG. 3B. While this example features a 2x2 outer product 348, other outer products of larger inputs are possible, including with different bit widths and element counts of A and B, using additional indexed shift/AND cells 346, where the cells 346 have the same or different circuitry configuration than that shown in FIG. 3B. In some cases, cells 346 can be implemented using a shift/AND cell 360 with 1-hot shift encoding, such as described with respect to FIG. 3D.

FIG. 3D illustrates a 4-bit×4-bit shift/AND cell with 1-hot shift encoding. Compared to the indexed shift/AND cell 320, a 4-bit×4-bit shift/AND cell 360 with 1-hot shift encoding can be implemented with less logic but more wires. The 4-bit×4-bit shift/AND cell 360 with 1-hot shift encoding also does not require B to be preprocessed or otherwise specially encoded (other than being 1-hot encoded). Here, there are two input signals to the 4-bit×4-bit shift/AND cell 360: an input signal A 362 (which is not required to be 1-hot encoded) and an input signal B 364.

The 4-bit×4-bit shift/multiply cell 360 includes a plurality of AND gates 366. Each AND gate can be coupled to one bit of signal A 362 and one bit of signal B 364. An OR gate 368 is provided for each cell output 370 bit, and the output of each OR gate 368 can be coupled to the corresponding cell output 370. The output of two or more AND gates 366 can be coupled via the input of an OR gate 368. In some cases where only one AND gate 366 could correspond to the value of the bit of the cell output 370, there is no OR gate 368. An AND gate 366 can correspond to the value of the cell output 370 if the combination of the bit of signal A 362 multiplied by the bit of the signal B 364 would have that value. In the figure, all combinations of the bits Aᵢ and Bⱼ can correspond to a cell output 370 pin Cₖ if Aᵢ and Bⱼ are of the form i+j=k, and all AND gates 366 that correspond to a particular cell output 370 pin can be joined by an OR gate 368. For each possible value of the signal B 364, each bit of the signal A 362 is routed to a different cell output 370 bit in C. This produces both the shift and the and operations since bits of the signal A 362 are not routed to any output bits in C if the signal B 364 is 0.

FIGS. 4A and 4B illustrate example latched bit circuits for a 1-hot path signature accelerator. Latched bit circuits can be used in a pre-circuit to represent the time since the last input frame with a set bit in a 1-hot format. FIG. 4A shows a truncating latched bit circuit 400. Referring to FIG. 4A, an input signal 402 is received and converted into an output signal 404 of the same number of bits. Effectively, the highest set bit of the input signal 402 is copied to the output signal 404 and all other bits are zeroed. In doing so, the truncating latched bit circuit 400 preserves only the highest bit of the input signal 402 and creates a 1-hot output in the process. A series of AND gates 406 can have inverters at some inputs and be coupled to individual pins associated with one bit of the input signal 402. The AND gates can be used to ensure that the output pin associated with a bit of the output signal 404 is not set if a higher pin associated with the input signal 402 is set. For example, the AND gate coupled to Q2, the second-highest output bit of the output signal 404 includes a bubble (representing an inverter or level shifter) coupled to D3, the highest input bit of the input signal 402, preventing Q2 from being set if D3 is set. OR gates 408 can be used to couple several signals that are higher than the associated output pin before being coupled to a lower AND gate 410. For example, as shown in FIG. 4A, the AND gate 410 coupled to Q1 also has a bubble on one pin, just like the AND gate 406 coupled to Q2. But, since Q1 has two corresponding signals in the input pins that are higher (D3, D2), those two signals are coupled to the OR gate 408 before being coupled to the AND gate 410—in this way, if either D3 or D2 are set, the resultant signal from the OR gate 408 will be high and will cause the output of the AND gate 410 to be low.

FIG. 4B shows a rounding latched bit circuit 420. Referring to FIG. 4B, the rounding latched bit circuit 420 allows for more resolution than the truncating latched bit circuit 400 of FIG. 4A. An input signal 422 is received and converted into an output signal 424, but, unlike the truncating latched bit circuit 400, the output signal 424 has one more (higher bit) than the input signal 422. Just as with the truncating latched bit circuit 400, an output pin is zeroed if an input pin corresponding to a higher output pin is set. However, if the highest set bit is immediately followed by another set bit (e.g., if D2 is the highest set bit and D1 is also set), then the bit one higher will be set instead.

For example, if the signal is 0b0110, in the truncating latched bit circuit 400, the output will be 0b0100, but for the rounding latched bit circuit 420, the output will be 0b1000. The rounding latched bit circuit 420 can include output AND gates 426 that have bubbles at one input, which is coupled with either the output of the next highest pin or a non-bubbled input of the AND gate coupled to the next highest pin. For example, for the output AND gate 426 corresponding to Q2, the input with the bubble can be coupled to the output Q3 or the non-bubbled input of the output AND gate coupled to Q3. The output AND gate 426 can also include a non-bubbled input coupled to an OR gate 428. The OR gate 428 can be coupled to a signal of the input corresponding to the output coupled to the output AND gate 426 (e.g., D3 can be coupled to the OR gate that is coupled to the non-bubbled input of the output AND gate coupled to Q3) as well as a rounding AND gate 430. The rounding AND gate 430 can be coupled to the next two lowest pins of the input (e.g., D2 and D1 for Q3).

FIGS. 5A and 5B illustrate circuits for temporal preservation of inputs for use in a 1-hot path signature accelerator. In some cases, the raw input frame is not a 1-hot signal—for example, there could be multiple sources of the same event/input. The latched bit circuits shown in FIGS. 4A and 4B can ensure that the input signal sent to the base path signature accelerator is 1-hot, but in some cases, it can be beneficial to reflect the fact that multiple event signals were received in a short period of time. Temporal preservation can be a method to introduce feedback into the pre-circuit around the empty cycle accumulator and allow dense inputs to be processed in a 1-hot manner even if the number of input events is not a power of 2.

FIG. 5A illustrates a basic circuit 500 with temporal preservation of inputs. Referring to FIG. 5A, an input signal 502 of N bits can be received and input to one input of a temporal adder 504. Another input of the temporal adder 504 can be a residual signal 506 of N bits that represents a residual of a temporally preserved previous input. The temporal adder 504 can add the input signal 502 and the residual signal 506 to produce an aggregate input signal 508 of up to N+1 bits, which is stored in an accumulator register 518. The aggregate input signal 508 can ensure that even lower bits of previous inputs are still propagated through the signal and considered if the input signal 502 has no set bits. The aggregate input signal 508 can be coupled to a latched bit circuit 510. The latched bit circuit 510 can be, for example, the truncating latched bit circuit seen in FIG. 4A. The latched bit circuit 510 can output a latched aggregate signal 512 of up to N+1 bits, which can be output to the next circuit. The latched aggregate signal 512 can also be coupled to a subtractor 514 along with the aggregate input signal 508. The subtractor 514 subtracts the latched aggregate input from the aggregate input stored in the accumulator register to calculate a pre-residual, which is stored in the accumulator register and represents the aggregate input signal 508 with the highest bit zeroed instead of set. The pre-residual can be output as pre-residual signal 516 to the accumulator register 518 and passed into the node where the residual signal 506 is stored upon an edge of a clock signal. The circuit 500 executes two equations on each clock cycle: 1: Q[x]=2^{└log(Res[x]+event[x])┘}2. Res[x+1]=Res[x]+event [x]−Q[x].

FIG. 5B illustrates a more elaborate circuit 520 with temporal preservation of inputs. As shown in FIG. 5B, the more elaborate circuit 520 can include much of the same circuitry as the basic circuit 500 of FIG. 5A, but further include an added subcircuit 530 that includes various elements designed to emit only a single bit any time an event arrives after a series of events without any set bits. This can help ensure that a group of events that arrives together and events that occur after a delay are properly differentiated.

In particular, the subcircuit 530 can be provided after the latched bit circuit 510. A first N+1-input OR gate 532 can be coupled to the output of the latched bit circuit 510 to see if any bits at all are set and compress to a one-wide signal indicating that either there are no set bits (0) or there is at least one set bit (1). There can be a similar second N+1-input OR gate 538 coupled to the output of the more elaborate circuit 520 with temporal preservation of inputs. The output of the second N+1-gate OR gate 538 can be coupled to the input of a second D flip flop 540 that passes an output signal from second N+1-gate OR gate 538 to an AND gate 534. The inputs of the AND gate 534 can be coupled to the output of the first N+1-gate OR gate 532 as well as a level shifted output of the second D flip flop 540 which can represent a previous-non-zero flag. The output of the AND gate 534 can be coupled to a select line of an output multiplexor 536. Input pins of the multiplexor 536 can be coupled to the output of the latched bit circuit 510.

As an example of operation, suppose there have not been any events recently. The residual of the circuit is 0. The latched output non-zero flag is 1. Then an input signal 502 with a value of 3 is received. The latched bit circuit 510 would produce a latched aggregate signal 512 of value 2. Since the latched output non-zero flag is 1, and since the latched aggregate signal 512 is non-zero, the output multiplexer 536 generates a 1. The value of 1 is subtracted from the aggregate input signal 508 to construct the next residual signal 506. 2 would be stored in the residual signal 506. 0 is stored to the latched output non-zero flag. Suppose the next input signal has no set bits. The residual signal 506 (2) is added to the input signal 502 (0) to produce the aggregate input signal 508 with a value of 2. Because the previous-non-zero flag is 0, the latched aggregate signal 512 can be sent to the output. The residual is 0. In this way a 1 is always output after a run of any number of 0's ends. Then, the truncating latched bit system takes over and spreads the events out in decreasing powers of 2.

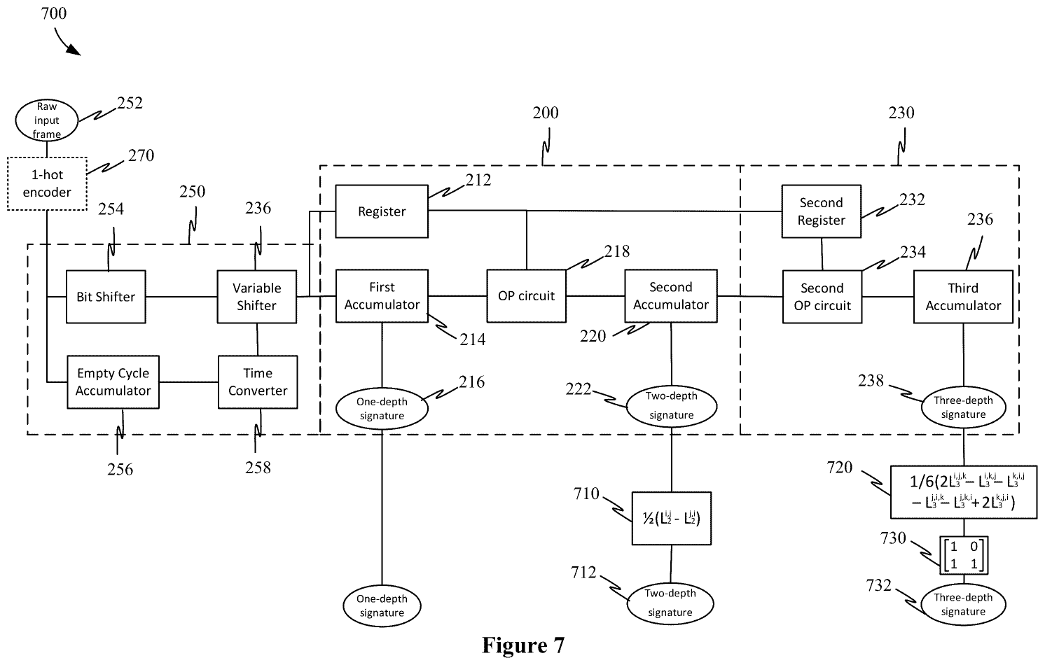

Such temporal preservation circuits (circuits 500 and 520) can thus be used in some implementations to generate a 1-hot signal that encodes the raw input into a 1-hot signal, which is reflected in FIGS. 2 and 7 as a 1-hot encoder 270 (and 1-hot priority encoders 604 and 608 of FIGS. 6A-6C).

FIGS. 6A-6C illustrate various example N-hot path signature accelerators.

Although the drawings show N=2, embodiments are not limited thereto and additional duplicated components can be added to achieve N>2. The 2-hot path signature accelerators shown in FIGS. 6A-6C can be used to increase the precision of the accelerator through some additional overhead circuitry. In these examples, the 1-hot bus and outer product circuit are duplicated, with the outputs combined before accumulating at a second accumulator. This duplication (with respect to the base accelerator of FIG. 1) can be found in the inclusion of a second register for storing a second 1-hot signal, the second 1-hot signal representing a portion of the input frame; a second outer product circuit that receives each element of the present summation from the first accumulator and each element of the second 1-hot signal stored in the second register to output a second present outer product; and an adder that combines the present outer product and the second present outer product before the second accumulator receives the present outer product, wherein the second accumulator outputs the present second-layer summation by adding the combined present outer product and the second present outer product to a previous second-layer sum of outputs from the adder within the timeframe. Specific examples are described in detail below.

Referring to FIG. 6A, a 2-hot path signature accelerator 600 receives input from a raw input frame 602, which can be an m-hot signal (i.e., where m is a number of non-zero/“1” bits in the set of bits of a frame). The m-hot bits are converted to a 1-hot signal by a first 1-hot priority encoder 604, which may be implemented such as described with respect to the circuit shown in FIG. 4A). The output of the first 1-hot priority encoder 604 is XORed (using XOR gate 606) with the m-hot bits received from the raw input frame 602 to cancel the most significant bits (MSBs) of the raw input frame 602 with the output of the XOR gate 606 converted to a 1-hot signal by a second 1-hot priority encoder 608, which may also be implemented such as described with respect to the circuit shown in FIG. 4A. The XOR gate 606 can be implemented as a bitwise XOR gate in which there is one XOR gate per bit for the whole input frame (with one side connected to the input frame and the other to the output of the first 1-hot priority encoder 604). In this manner, using the two 1-hot priority encoders 604, 608 and the XOR gate 606, the top two bits are returned in two 1-hot busses. The output of the first 1-hot priority encoder 604 and the output of the second 1-hot priority 608 are combined by a first adder 610, which can be considered to add the two MSBs (e.g., from each 1-hot signal). In some cases, the first adder 610 can be implemented by a bitwise OR instead of an adder.

Although not shown, a first register can be included to store the 1-hot signal output from the first 1-hot priority encoder 604 and a second register can be included to store the 1-hot signal output from the second 1-hot priority encoder 608. In some cases, such registers can be incorporated in the circuitry for the 1-hot priority encoders.

A first accumulator 612 receives the output of the first adder 610. The first accumulator 612 calculates a present summation (also referred to as a one-depth signature L1) by adding the output of the first adder 610 to a previous sum. Instead of a single outer product circuit, the 2-hot path signature accelerator 600 includes two outer product (OP) circuits: first OP circuit 614A and second OP circuit 614B. The first OP circuit 614A receives the present summation/L1 from the accumulator 612 and the 1-hot signal output from the first 1-hot priority encoder 604 to calculate a first present outer product. The second OP circuit 614B receives the present summation/L1 from the accumulator 612 and the 1-hot signal output from the second 1-hot priority encoder 608 to calculate a second present outer product. The first present outer product and the second present outer product are combined at a second adder 616 before being input to a second accumulator 618. The second accumulator 618 can calculate a present second-layer summation by adding the combined present outer product to a previous second-layer sum of outputs from the adder 616 within a timeframe. The second accumulator 618 can output or store the present second-layer summation as a two-depth signature (L2), which can be independent of or associated with the one-depth signature L1.

Referring to FIG. 6B, another 2-hot path signature accelerator 620 is shown that is similar to the 2-hot path signature accelerator 600 of FIG. 6A; however, instead of receiving a combined 1-hot signal from outputs of the first 1-hot priority encoder 604 and the second 1-hot priority encoder 608, a first accumulator 622 is coupled to receive the m-hot signal from the raw input frame 602. Although not shown, a register can be included on the input bus from the raw input frame to store the m-hot input frame used by the accumulator 622.

FIG. 6C shows an example 2-hot path signature accelerator system 630 that includes the 2-hot path signature accelerator 620 and a pre-circuit that includes a bit shifter 632, an empty cycle accumulator 634, a time converter 636, and a fixed point divider 638. The pre-circuit is used to obtain inputs and format the inputs for easier processing by the signature accelerator 620.

The bit shifter 632 and the empty cycle accumulator 634 are coupled to an input bus to receive a raw input frame 602. The input bus can be, for example, connected to a PMU or some other source of data inputs such as described with respect to FIG. 2; however, the raw input frame 602 can be m-hot (i.e., including one or more set bits in a given frame).

The bit shifter 632 can left-shift the raw input frame 602 a predefined number of times, for example eight times, to produce a shifted input frame. The left-shift operation provides a fixed-point encoding of the input, which is used by the fixed point divider 638.

The empty cycle accumulator 634 can be a circuit designed to count the number of empty cycles (i.e., cycles where there are no set bits). The empty cycle accumulator 634 can be, for example triggered on a clock cycle (that can be the same clock cycle associated with the loading of the raw input frame 602 in the input bus) and can increment upon receiving a clock signal unless reset. The empty cycle accumulator 634 can also include a reset pin—where the reset pin detects whenever a set bit is in a currently processing raw input frame 602. In some cases, the empty cycle accumulator 634 can be a circuit designed to only count the number of times a specific event is present. In some cases, the empty cycle accumulator 634 can include feedback to allow for temporal preservation of inputs. Examples of circuits for temporal preservation of inputs are shown in FIGS. 5A and 5B.

The time converter 636 is coupled to the empty cycle accumulator 634. The present output of the empty cycle accumulator 634 (e.g., the number of cycles that have no set bits) can be received by the time converter 636 when an enable is triggered. The enable can be triggered when the raw input frame 602 includes one or more set bits. The time converter 636 can be implemented using an encoder that triggers when an input is received with set bits. In some cases, the time converter 636 is a priority encoder. Such encoders yield the index of the highest bit. In some cases, the time converter 636 is a modified priority encoder can be used, for example, a 1-hot priority encoder (see e.g., the circuit shown in FIG. 4A). In some cases where the time converter 636 is implemented as a 1-hot priority encoder, the time converter 636 can be implemented using bit latches such as shown in FIGS. 4A and 4B to generate a 1-hot encoding of time delay.

The fixed point divider 638 receives the N bits from the bit shifter 632 and the output D of the time converter 636 so that the time can be encoded in the m-hot signal used as input to the first accumulator 622 and to generate the two 1-hot signals used by the OP circuits (e.g., OP circuit 614A, OP circuit 614B).

Although two layers are shown in FIGS. 6A-6C, more layers of accumulator, adders, and outer product circuits can be included to achieve desired precision. These duplicated components can be included for each depth of the signature generated (e.g., three-depth signature, etc. as shown and described with respect to FIG. 2).

FIG. 7 illustrates an embodiment of a logarithmic-based 1-hot path signature accelerator. It is possible to reduce the data size of the path signature and increase the sensitivity of any ML by reducing the path signature to a linearly independent form by using a log signature instead of a typical path signature. While computing a log signature directly can be challenging, a path signature can be calculated as an intermediate step and transformed in a post-processing step. The process of configuring a path signature to log signature transform may have to be calculated beforehand but can be simple to execute in circuitry.

The Log Signature can be computed at the last stage of the accelerator. Referring to FIG. 7, a 1-hot path accelerator such as the 1-hot path accelerator 200 of FIG. 2 (or even an N-hot path accelerator) can become a logarithmic-based 1-hot path signature accelerator 700 by the inclusion of post-processing element 710 that generates a logarithmic two-depth signature 712 and post-processing element 720 and matrix 630 that generates a logarithmic three-depth signature 732.

A comparatively small number of operations are performed because only the Lyndon words of the expanded signature are computed. The result can then be projected, which takes a small number of additional operations. Thus, the above computation only needs to be performed for each Lyndon word. This means

$$\frac{{d}^{2} - d}{2}$$

subtractions for L₂. However, for L₃ (the second and third layer of the path signature), the count of Lyndon words is more complex. In general:

$$count ( {L}_{l} ) = \frac{1}{l} {\sum }_{q \vert l} μ ( q ) {d}^{l / q}$$

where: l is the length of the Lyndon words; q is an integer divisor of l; μ is the information-theoretical Mobius function; and d is the dimensionality of the Lyndon words (how many letters there are in the alphabet). For example, with d=5, l=3, the total is 40.

The post-processing step can be performed by computing a set of expanded log signature elements from the signature elements. The entire set of expanded log signature elements need not be computed directly, as any indexed by a Lyndon word can be potentially redundant—as such, fewer elements need be stored. The “expanded” log signature is called “expanded” because the components are not linearly independent. The number of terms can be reduced by projecting into a linearly independent basis, such as the Lyndon basis or Hall basis.

The process to project into the Lyndon basis can start by grouping all Lyndon words into anagram groups. Then, for each singleton anagram group, copy the element from the expanded log signature into the log signature. For each non-singleton anagram group, construct a projection matrix, invert the projection matrix, multiply the anagram elements of the expanded log signature, and then the resulting vector into the log signature. For l=3, d=5, the inverted projection matrix is the same for all anagram groups:

$$M = [ \begin{matrix}1 & 0 \\ 1 & 1\end{matrix} ] .$$

This means that the projection only adds a single addition to the original computation. There are only 10 anagram groups for l=3, d=5. Given this simplicity, it may be plausible to leave the projection out of the accelerator and let an ML system that consumes log signatures “learn” the projection itself.

The Lyndon basis can discard all terms that are not a Lyndon word. This has no effect on L₁ⁱ. Discarding has no effect on L₂^{i,j})=where 1≤i<j≤d because 1≤i<j≤d forms the set of Lyndon words in L₂. L₃ is more complicated. The set of Lyndon words is not described by a simple relation, but rather it is defined as the set of “words” that are lexicographically the smallest of all their rotations.

The Expanded Log Signature is derived from the formal logarithm taken in Tensor Space:

$$log ( S ) = {\sum }_{n \geq 1} \frac{{( - 1 )}^{n - 1} {( S - 1 )}^{n}}{n} .$$

For the first 3 layers of path signature, the components of the result are given by:

$${L}_{1}^{i} = {S}^{i} , {L}_{2}^{i , j} = \frac{1}{2} {S}^{[ i , j ]} = \frac{1}{2} ( {S}^{ij} - {S}^{ji} ) where \\ 1 \leq i < j \leq d , and {L}_{3}^{i , j , k} = \frac{1}{3} {S}^{i , j , k <} - \frac{1}{6} {S}^{i , k , j} - \frac{1}{6} {S}^{k , i , j} - \frac{1}{6} {S}^{j , i , k} - \frac{1}{6} {S}^{j , k , i} + \frac{1}{3} {S}^{k , j , i} where \\ 1 \leq i \leq j \leq k \leq d .$$

In some special cases (such as i=j or j=k), several terms will cancel out. The special case of i=j=k can always be discarded since the result is always 0.

In order to compensate for the ½ fraction in L₂ and ⅓ and ⅙ factors in L₃, the accelerator computes L₁, 2L₂, and 3L₃, which simplifies the accelerator and does not change any dependent algorithms. For l=3, d=5, this results in: 0 operations for L₁; 10 subtraction operations for computing expanded L₂; and for L₃: 40×5 add/subtract for computing expanded L₃ and 10 add operations for projection. When computing the expanded log signature, there are also special cases of the computation:

$${L}_{3}^{i , j , k} = \frac{1}{3} {S}^{i , j , k} - \frac{1}{6} {S}^{i , k , j} - \frac{1}{6} {S}^{k , i , j} - \frac{1}{6} {S}^{j , i , k} - \frac{1}{6} {S}^{j , k , i} + \frac{1}{3} {S}^{k , j , i} where \\ i = j or j = k ,$$

where several terms will cancel out. These operations can be pruned from the hardware since the operations have no effect. This further reduces the count above. The Log Signature can for example reduce the number of elements in the path signature from 155 elements down to 55 elements, saving nearly ⅔ storage and bandwidth.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. An apparatus comprising:
a register for storing a 1-hot signal, the 1-hot signal having, at most, one bit of each element set of an input frame;
a first accumulator for calculating a present summation by adding the input frame to a previous sum, wherein the previous sum is the sum of all previous input frames inputted to the 1-hot path signature accelerator within a timeframe;
an outer product circuit that receives each element of the present summation from the first accumulator and each element of the 1-hot signal stored in the register to output a present outer product, wherein the outer product circuit is reduced to a logical operation by the 1-hot signal of the input frame having at most one bit of each element set; and
a second accumulator that outputs a present second-layer summation by adding the present outer product to a previous second-layer sum of outputs from the outer product circuit within the timeframe.

2. The apparatus of claim 1, further comprising:
a second register for storing a second 1-hot signal, the second 1-hot signal representing a portion of the input frame;
a second outer product circuit that receives each element of the present summation from the first accumulator and each element of the second 1-hot signal stored in the second register to output a second present outer product; and
an adder that combines the present outer product and the second present outer product before the second accumulator receives the present outer product,
wherein the second accumulator outputs the present second-layer summation by adding the combined present outer product and the second present outer product to a previous second-layer sum of outputs from the adder within the timeframe.

3. The apparatus of claim 2, further comprising:
a first 1-hot priority encoder providing the 1-hot signal from a received m-hot signal;
an XOR gate receiving the 1-hot signal from the first 1-hot priority encoder and the m-hot signal; and
a second 1-hot priority encoder receiving an output of the XOR gate to provide a second 1-hot signal.

4. The apparatus of claim 3, further comprising an adder or a bitwise OR that is coupled to the first accumulator to provide the input frame to the first accumulator, wherein the adder or the bitwise OR receives the 1-hot signal provided by the first 1-hot priority encoder and the second 1-hot signal provided by the second 1-hot priority encoder.

5. The apparatus of claim 1, further comprising:
one or more higher-layer calculator circuits coupled to the register and an immediately previous accumulator, the one or more higher-layer calculator circuits each comprising:
a second outer product circuit comprising a series of logic gates that perform a logical operation between each bit of a present summation output from the immediately previous accumulator and each bit of the input stored in the register to output a present higher-level outer product; and
a third accumulator that outputs a present higher-layer summation by adding the present higher-level outer product from the second outer product circuit to a previous higher-layer sum of outputs from the second outer product circuit within the timeframe.

6. The apparatus of claim 1, wherein the outer product circuit comprises a plurality of AND gates that each connect one bit of the present summation output from the first accumulator and one bit of the input stored in the register and between the plurality of AND gates connect each combination thereof exactly once.

7. The apparatus of claim 1, wherein the outer product circuit comprises:
a shift circuit coupled to the register to shift the input stored in the register;
a plurality of multiplexors, wherein the shifted input from the register is used to select between consecutive bits of the present summation output from the first accumulator; and
a plurality of AND gates, wherein each AND gate is coupled to one of the plurality of multiplexors and a signal that indicates that the input stored in the register is nonzero.

8. The apparatus of claim 1, wherein the outer product circuit comprises:
a plurality of AND gates, wherein each AND gate is coupled to one bit of the present summation output from the first accumulator and one bit of the input stored in the register; and
a plurality of OR gates, wherein each OR gate receives, as input, outputs of a set of corresponding AND gates of the plurality of AND gates.

9. The apparatus of claim 1, further comprising a logarithmic function circuit that converts a path signature generated by the path signature accelerator into a log signature.

10. The apparatus of claim 1, further comprising:
an input bus that receives a raw input frame;
an empty cycle accumulator that increments on clock cycles when the raw input frame does not have any set bits and resets when the raw input frame is received with set bits;
an encoder coupled to the empty cycle accumulator that triggers when the raw input frame is received with set bits; and
a second outer product circuit, wherein the second outer product circuit is M×1, wherein the M inputs are received from the input bus and the x1 input is received from the encoder.

11. The apparatus of claim 10, wherein the empty cycle accumulator is an adder.

12. The apparatus of claim 10, wherein the encoder is a latched bit circuit.

13. The apparatus of claim 10, further comprising a 1-hot encoder that encodes time information with the raw input frame before input to the empty cycle accumulator.

14. The apparatus of claim 1, further comprising:
an input bus that receives a raw input frame;
a left-shift bit shifter that left-shifts the raw input frame a predetermined number of times;
an empty cycle accumulator that increments on clock cycles when the raw input frame does not have any set bits and resets when the raw input frame is received with set bits;
an encoder coupled to the empty cycle accumulator that triggers when an input is received with set bits; and
a variable shifter that right-shifts the output of the left-shift bit shifter a number of times based on an output from the encoder.

15. The apparatus of claim 14, wherein the encoder is a priority encoder or a 1-hot priority encoder.

16. The apparatus of claim 14, wherein the variable shifter comprises a second outer product circuit.

17. The apparatus of claim 16, wherein the second outer product circuit comprises:
a shift circuit coupled to the register to shift the input stored in the register;
a plurality of multiplexors, wherein the shifted input from the register is used to select between consecutive bits of the output of the left-shift bit shifter; and
a plurality of AND gates, wherein each AND gate is coupled to one of the plurality of multiplexors and a signal that indicates that the output of the encoder is nonzero.

18. The apparatus of claim 16, wherein the second outer product circuit comprises:
a plurality of AND gates, wherein each AND gate is coupled to one bit of the output of the left-shift bit shifter and one bit of the output of the encoder; and
a plurality of OR gates, wherein each OR gate receives, as input, outputs of a set of corresponding AND gates of the plurality of AND gates.

19. The apparatus of claim 14, further comprising:
an accumulator register;
an adder coupled to the input bus to receive the raw input frame and add the raw input frame to a residual stored in the accumulator register to calculate an aggregate input, the aggregate input being stored in the accumulator register;
a latched bit circuit that creates a latched aggregate input of a 1-hot signal from the aggregate input;
a subtractor that subtracts the latched aggregate input from the aggregate input stored in the accumulator register to calculate a pre-residual, the pre-residual being stored in the accumulator register; and
a delay circuit that passes the pre-residual into a node where the residual is stored upon a clock cycle.

20. The apparatus of claim 1, further comprising:
an input bus that receives a raw input frame;
an empty cycle accumulator that increments on clock cycles when the raw input frame does not have any set bits and resets when the raw input frame is received with set bits;
an encoder coupled to the empty cycle accumulator that triggers when the raw input frame is received with set bits; and
a demultiplexor, wherein input pins of the demultiplexor coupled to the input bus to receive the raw input frame and wherein select lines of the demultiplexor are coupled to the output of the encoder.
